(19) United States
(12) Patent Application Publication
(10) Pub. No.: US 2019/0087949 A1
(43) Pub. Date: Mar. 21, 2019

(54) METHOD FOR CHARACTERIZING MATERIALS WITH INCLUSIONS

(71) Applicant: YXLON INTERNATIONAL GMBH, Hamburg (DE)

(72) Inventor: Felix WOELK, Hamburg (DE)

(21) Appl. No.: 16/127,920

(22) Filed: Sep. 11, 2018

(30) Foreign Application Priority Data
Sep. 15, 2017 (DE) 102017121490.9

(51) Int. Cl. G06T 7/00

(52) U.S. Cl. CPC G06T 7/001; G06T 7/0008; G06T 2207/30152; G06T 2207/10116; G06T 2207/20032; G06T 2207/20076

(57) ABSTRACT

A method for the image processing of data of a difference image formed from an original image and a filtered image. Air inclusions in a self-contained volume can occur e.g., adhesive points, soldering points or welded seams. In the field of adhesive layers for semi-conductor components or micro-electronic components, it is important to characterize each adhesive surface with respect to the proportion of the air inclusions present therein. The more accurately the air inclusions can be characterized, the more reliably it can be determined whether the adhesive surface is unuseable scrap or not. The adhesive surfaces are characterized through a method in which, based on probabilities of the presence of an air inclusion in a specific pixel, the proportion of air inclusions in the image is calculated. A linking of conditional probabilities of at least two features stochastically combined with each other can be effected for this image region.

### CROSS REFERENCE TO RELATED APPLICATION

This application claims priority under 35 U.S.C. § 119 to German patent application number DE 102017121490.9, filed on Sep. 15, 2017, the contents of which is incorporated by reference herein in its entirety.

### BACKGROUND OF THE INVENTION

### 1. Field of the Invention

The present invention relates to a method for examining air inclusions in materials, in particular in adhesive surfaces or soldering points. Furthermore, the invention relates to a computer program for the automated application of the method, in particular in the context of material testing.

### 2. Description of Related Art

Air inclusions in adhesive surfaces or (flat) soldering points, also called voids, as they are present as hollow spaces, can usually be determined in that, in the case of an image or a recording of the adhesive surface, e.g. of an X-ray image, a filtering of the original image is effected. The percentage proportion of air inclusions in relation to the surface or the volume of the examined material is of interest (so-called “void calculation”) e.g. in order to be able to assess whether a material is still formed sufficiently solid, stable or cohesive, or whether it must be feared that it can no longer perform a specific function because of too many inclusions. A void calculation (VC) is carried out as standard e.g. during the production of high-performance LEDs, in order to ensure that, in a thermally conductive material, no regions with too many or too-large air inclusions are present. This is because these would possibly lead to insufficient cooling capacity or even destruction of the components, in particular in the case of included air bubbles.

The capture and calculation of the inclusions or hollow spaces can be effected e.g. depending on a threshold value for a specific feature of the X-ray image. The air inclusions can be represented e.g. in a different colour or brightness, or in different greyscales than regions unaffected by air inclusions, with the result that an image analysis can be effected via the greyscale value. A VC can usually be effected by calculating the difference between an original image and a low-pass filtered image, wherein it is attempted to define the threshold value such that it can be used to evaluate the difference image. For an informative image analysis, in addition to the threshold value, a mask size of the low-pass filter is also to be defined manually. For a respective image region, a yes/no statement for an air inclusion is made on the basis of a specific greyscale value in the difference image. A manual threshold value formation in the difference image is more useful than a threshold value formation in the original image in that a non-uniform illumination of the image (greyscale value progression) can thereby be compensated for. The low-pass filtered image contains the average greyscale value in the surroundings. The size of the surroundings is determined by the mask size of the low-pass filter. The difference image thus contains the deviation of the individual pixel greyscale value from the average greyscale value of all the pixels in the surroundings. Through the threshold value formation in the difference image, the deviation of the greyscale value from the average greyscale values of the surroundings is detected. Voids are also recognized visually in the same way: they appear with brighter greyscale values than the surroundings. In the case of threshold value formation in the original image, the absolute brightness of the pixel in relation to an overall threshold value is detected. This leads to bright structures being detected, independently of whether they are brighter than their surroundings.

A greyscale value progression of the image which is usually present and more or less strongly pronounced, has a particular influence on a correct calculation result. By “greyscale value progression” is preferably meant the deviation of the greyscale value in relation to a specific average greyscale value or a neighbouring pixel in a specific direction, which is not explained by inclusions, but e.g. by the type of image capture or inhomogeneities (e.g. varying thickness) in the examined material itself. A greyscale value progression corresponds to a variation in the illumination time, depending on the position in the image.

A pronounced greyscale value progression makes an evaluation carried out on the basis of a threshold value difficult: in the case of an image e.g. fluctuating greatly in brightness, an evaluation based solely on a specific threshold value for the greyscale value is inadvisable, as it is very unlikely that the threshold value can be precisely defined such that all the air inclusions can certainly be captured, but no noise or any artefacts. Rather, there are frequent cases in which such a threshold value does not even exist and thus defining any threshold value manually implicitly involves a disadvantageous inaccuracy.

It is therefore not usually satisfactorily possible to capture air inclusions solely via a specific threshold value for the greyscale value, wherein the threshold value formation is effected in the difference image. In the images to be examined, greyscale value progressions or greyscale value ranges in which the threshold value would fall, are usually present and therefore specific air inclusions (weaker or smaller signals) are not represented. If a pronounced greyscale value progression is present, it is usually also not possible, based on the difference image, to define a threshold value such that all the inclusions are captured but a noise is not also wrongly captured as an inclusion. A reasonably accurate evaluation is usually also made difficult by an insufficient image quality which leads to an unfavourable selection of the threshold value.

### SUMMARY OF THE INVENTION

The object is to detect in materials inclusions such as e.g. air inclusions or other hollow spaces or also cavities at least partially filled with a medium, in the most accurate way possible. An object is also to provide a method for locating air inclusions as accurately and capturing them as completely as possible. Not least, an object is to determine the percentage proportion of air inclusions in adhesive or soldering points as accurately as possible.

At least one of the objects is achieved by a method according to claim 1 as well as by a computer program according to claim 11 and also by a storage medium according to claim 13. Advantageous developments are described in the dependent claims, wherein the individual features specified in the different dependent claims can in principle be combined with each other, unless this is explicitly ruled out.

The method according to the invention is provided for determining inclusions in a closed volume on the basis of an image of the volume in which, for a respective pixel depending on a threshold value for a first feature of the pixel, a yes/no statement is made as to whether an air inclusion is present in the pixel, wherein the first feature relates to a difference image from an original of the image and a filtered image of the image, wherein according to the invention it is proposed that the filtered image is formed by a median filter.

By such a method, a difference image can be determined more robustly from original image and median-filtered image. The first feature is preferably based on a greyscale value assigned to a specific pixel. The median filter offers, e.g. compared with a low-pass filter, the advantage that median values can be selected from a (greyscale value) list, via which a more suitable or more realistic greyscale value, instead of a strongly deviating greyscale value, can be assigned to a pixel.

The inclusions are usually present as air inclusions, at least in the case of adhesive or soldering points. However, the inclusions can generally refer to any hollow spaces by which the actual material is interrupted, irrespective of whether the hollow spaces are filled with a medium or not. The image can be e.g. an X-ray image. The volume can be any self-contained adhesive, soldering or welding region which is to be analyzed, wherein the term “self-contained” can be understood to mean that any inclusions or discontinuities are present in the material composition inside the volume not visible or accessible from outside. This makes analysis based on an image, e.g. an X-ray image, necessary. The volume is therefore preferably the material sample examined, or a specific region of a component, e.g. the intersection between an LED and a component on which it is mounted. In principle, the volume can also be any desired solid part, e.g. a cast or extruded or injection-moulded or pressed component. The invention therefore also relates generally to the field of material testing.

The first feature can be the greyscale value in a specific pixel, in particular a greyscale value intensity I.

In the case of the application of a median filter a specific mask can be used. The mask serves to determine the local surroundings U of a respective pixel, in which the filter is applied (so-called neighbourhood). In the case of the application of the median filter, the mask size (so-called locality) can either itself be defined manually or automatically. The larger the mask is selected, the more neighbouring pixels are considered during the filtering and the median value is determined on a broader basis. A larger mask requires more computing power. In order to save computing time, a star-shaped region or surroundings U can be used for the median filter. Only pixels on the horizontal, on the vertical and on both diagonals are included in the calculation of the median value. The mask is regularly two-dimensional, but can theoretically also be one-dimensional, however narrow lines perpendicular to the mask are then possibly filtered away. The mask size is, furthermore, set manually; to date there is no automation.

The median (med) itself can be determined according to Niklaus Wirth's calculation method, which is also described in more detail in the following citation: Niklaus Wirth, Algorithms+data Structures=Programs, Englewood Cliffs: Prentice-Hall, 1976, pp. 366.

According to a preferred development of the method, the threshold value is automatically determined based on the noise in the difference image.

Because of this, it is no longer necessary to define the threshold value manually. This can save time or also avoid incorrect entries or disadvantageous or inaccurate calculation bases. A user no longer has to adopt a cautious approach towards a supposedly optimum calculation result through the trial-and-error selection of a threshold value.

An automatic determination of a threshold value can be made via an automatic determination of the image noise in the difference image, in particular through the so-called X84 criterion. The X84 criterion is based on determination of the median of the absolute deviation of the first feature from the median (med). The X84 criterion is also described in detail in the following citation: Hampel FR, Rousseeuw P J, Ronchetti E M, Stahel W A. Robust Statistics: the Approach Based on Influence Functions. Wiley Series in Probability and Mathematical Statistics, John Wiley & Sons, 1986.

By “image noise” is meant a disturbance which occurs independently of the actual image information and has to be captured together with the image information, and makes it difficult to evaluate the image, in particular when the noise is stronger than the weakest image signals of inclusions, in particular in the case of very small inclusions. A noise can be superimposed on a greyscale value progression and have a distribution completely independent of the greyscale value progression.

The X84 criterion, as mentioned, calculates the median σX84(x) of the absolute deviation from the median (med). This approximately corresponds to a robust determination of the standard deviation. The calculation of the median σX84(x) can be effected via the greyscale value intensities I in local surroundings U of the examined pixel at the position x, that can be set via the mask size:

σX84(x)=med|I(x ∈U)−med(I(x∈U))| (Equation 1.1)

According to a preferred development of the method, the yes/no statement is only made right at the end after consideration of all the features based on a probability of the presence of an inclusion established for a respective pixel. Conditional probabilities are preferably regarded as probabilities. Through the consideration of probabilities, it can be avoided that a yes/no statement has to be effected solely on the basis of a possibly inaccurately manually determined threshold value.

The so-called “Bayes' theorem” allows the calculation of conditional probabilities:

$$p ( s \vert m ) = \frac{p ( m \vert s ) \cdot p ( s )}{p ( m )} = \frac{p ( m \vert s ) \cdot p ( s )}{{\sum }_{k} p ( m \vert s = k ) \cdot p ( s = k )} \qquad ( Equation 1.2 )$$

Bayes' theorem can be used in the calculation of conditional probabilities in the context of so-called Bayesian statistics. In Bayesian statistics, three boundary conditions are usually present:

the probability is defined not only in the classical sense as probability of an event but also as probability of statements, wherein the probability is related to the plausibility of the statement and is to be understood as a measurement of the plausibility; the more that is known about a specific statement, the more plausible the statement is; (in the case of the image calculation considered here, the statement can relate e.g. to a specific greyscale value in a pixel and thus indirectly to the presence of an inclusion);

conditional probabilities are considered or calculated on the basis of Bayes' theorem;

random variables are defined, which can nevertheless stand for constants.

When Bayes' theorem is applied, a probability distribution is determined for a feature, from which the plausibility of values or statements of the features is determined.

In the above equation 1.2 the variable s is a state, in particular one of two complementarily possible states, in the case considered namely an inclusion is either present or not, and m is a feature or one of several features examined, for example the greyscale value or the greyscale value intensity of the difference image Δl.

Here p(s|m) is the so-called a posteriori probability, i.e. the sought probability of a pixel belonging to an inclusion if a measurement of the feature m is present. Furthermore, p(m|s) is the so-called likelihood function, i.e. the conditional probability of the feature m, when the state s is established, and p(s) is the so-called prior. In the case of two states the non-informative prior has the value 0.5. Each of the two states has the same probability.

In the following, a prior with a value p(s)=0.5 is assumed by way of example.

Example: p(s=Inclusion|m(Δl=a)) is the probability that a pixel belongs to an inclusion when a specific greyscale value a has been established in the difference image.

$$p ( Δ I \vert s = Void ) = \{ \begin{matrix}1 - c & if a * ( Δ I - t ) + 0.5 > 1 - c \\ a * ( Δ I - t ) + 0.5 & or \\ c & if a * ( Δ I - t ) + 0.5 < c \end{matrix} \qquad ( Equation 1.3 )$$

The likelihood function p(m|s) is modelled by the following function:

Here c is a small constant, in particular in the range from 0 to 0.5. The value a corresponds to a gradient which results from the image noise, in particular from the x84 criterion multiplied by the sensitivity (input parameter).

Alternatively, it would be possible to use the logistical function as another modelling. The formula thereof indicates the probability of a specific greyscale value in the difference image, provided that the pixel depicts an air inclusion. The greyscale value of the difference image is the input value of the formula. The gradient results from the noise in the image, with the result that the gradient is greater as the noise is smaller. The threshold value t results from the image noise multiplied by the sensitivity.

The likelihood function for a background of the difference image can be modelled complementarily to this:

P(Δl|s=background)=1.0−p(Δl|s=inclusion)

By “background” is meant that part of an image which depicts solid material without inclusions, and which is optionally superimposed by a noise, perceptibly or not perceptibly. The background thus provides a signal typical of the material examined.

According to a preferred development of the method, a second feature of the pixel is defined and a probability calculated for the first and second feature respectively.

A gradient along a search direction can be used as second feature. The derivation of the intensity depending on location is to be seen as gradient. The second feature preferably relates to an absolute amount and an orientation of gradient pairs, in particular edge pairs. By “edge pairs” is meant a pair of edges in which the brighter greyscale values lie between the edges, wherein one edge can be formed by a conditional dependence between the features. For example, a first edge and a second edge can together form an edge pair. By “orientation” is meant the two-dimensional alignment of one respective edge in relation to a defined direction, e.g. an x- or y-coordinate axis of the difference image. A pair has an opposite orientation when the two gradients have opposite signs. The second feature can be determined on the basis of the difference image, preferably on the basis of a gradient image established from the difference image, which can be taken as the basis for a list with gradients with an absolute value above a specific threshold value t.

The gradient is the change in the greyscale value along a specific direction. If the gradient is greater than zero, a transition of the greyscale values from dark to light takes place in the image. The greater the gradient, the more rapidly the transition takes place. If the gradient is negative, a transition of the greyscale values from light to dark takes place. If the intensity in the image is constant, the gradient is zero. Very great or very small gradients are perceived as edges in the image. An edge pair is a pair of two gradients with a very high absolute amount, one of which is greater and one smaller than zero. An edge pair is the same as a gradient pair.

According to a preferred development of the method, the first and second features are combined with each other stochastically and the probabilities of the first and second features linked to each other.

More than two features can also be stochastically combined with each other, before a yes/no statement is made. The information gained in the case of the combination can likewise form a broader basis for the yes/no statement than each feature considered on its own, with the result that the yes/no statement can be made with better certainty and the proportion of the inclusions can be determined more accurately.

A combination of the first and second features can be effected by means of Bayesian statistics for conditional probabilities, in that the probabilities of the features can be linked to each other by integration of the second feature. From each feature, a probability can first be calculated in isolation. These probabilities can then be linked to Bayesian statistics for conditional probabilities, in particular in that a sought probability of a respective preceding feature serves as prior for the further calculation. By “linking” is thus meant an integration process in which, in addition to a probability established on the basis of a first feature, a further probability is included in the calculation and considered. It is possible to combine any number of features or probabilities, and a more accurate result image can already be established in the case of the combination of two features. “Linking” and “combination” are here used synonymously. Features are combined, which is possible by linking the probabilities. “Integration” is defined by Bayes' formula.

Preferably, two features are combined, namely on the one hand the greyscale value of a pixel of the difference image between the original image and the median-filtered image, and on the other hand so-called gradient pairs in the difference image, wherein the gradient pairs are defined in relation to a specific search direction. The inclusions can be recognized by means of the second feature, in particular as follows: in the difference image, compatible edge pairs or gradient pairs are sought in the image in four different directions, e.g. north N—south S, west W—east E, north-west NW—south-east SE, north-east NE—south-west SW, or vertically, horizontally and in both diagonals. Depending on the orientation of the edges, either an inclusion or background is situated between them: if the edges orientated in the search direction are orientated such that the brighter pixels lie between them, an inclusion is present between them, and if the edges are orientated such that the darker pixels lie between them, no inclusion is present between them. Gradient image and difference image are in principle different. The gradient image is only present when the gradients have been calculated for each pixel in the difference image.

By “compatible edge pairs” is meant edge pairs which have an opposite orientation and an at least approximately equal absolute amount.

In addition to the greyscale value and the gradient pairs, or orientation thereof, e.g. a liekelihood function according to equation 1.5, can be defined as further features. Any image operations which could also serve individually for recognizing air inclusions can also be used as features. The more statistically independent features are combined, the greater is the certainty of the result.

In the following, a modelling is described especially for the case where a gradient or a gradient pair is used as the second feature in the difference image.

The second feature preferably relates to gradients in the difference image and is preferably based on a pair of two gradients with a comparable absolute amount. The second feature cannot be directly described with a single formula. Rather, for determining the second feature along a search direction (e.g. horizontally) all the gradients in the difference image with an absolute value above a specific threshold value t are collected in a (gradient) list. However, a gradient is only included in the list when its absolute value is a local maximum. Now gradient pairs with opposite orientation but an approximately equal absolute amount are sought in the list. A feature now consists of a gradient pair g(x1), g(x2) with x1<x2. The likelihood function for all the positions x∈[x1, x2] along the search direction, which are bracketed by such a gradient pair, can be modelled as follows:

$$p ( g ( {x}_{1} ) , g ( {x}_{2} ) \vert s = Void ) = \{ \begin{matrix}0.5 + c & if g ( {x}_{1} ) > 0 ⋀ g ( {x}_{2} ) < 0 \\ 0.5 & or \\ 0.5 - c & if g ( {x}_{1} ) < 0 ⋀ g ( {x}_{2} ) > 0\end{matrix} \qquad ( Equation 1.4 )$$

with a constant c<0.5.

Another modelling is also possible, e.g. in that the probability is modelled depending on the distance between the edge pair, such that a large distance leads to a lower probability.

The likelihood function for background can again be implemented complementarily to this:

p(g(x1),g(x2)|s=background)=

1.0−p(g(x1),g(x2)|s=inclusion)

Gradients g(x1) without partners in the above (gradient) list, i.e. gradients to which no corresponding gradient with opposite orientation and an approximately equal absolute amount has been found, also contribute to the determination of sought probabilities. Thus, the likelihood function for all the subsequent positions x in the search direction can be modelled as follows:

$$p ( g ( {x}_{1} ) \vert s = Void ) = \{ \begin{matrix}c \cdot exp ( - ( x - {x}_{1} ) \text{/} s ) + 0.5 & if g ( {x}_{1} ) > t \\ 0.5 & or \end{matrix} , and \\ p ( g ( {x}_{1} ) \vert s = Background ) = \{ \begin{matrix}- c \cdot exp ( - ( x - {x}_{1} ) \text{/} s ) + 0.5 & if g ( {x}_{1} ) < t \\ 0.5 & or \end{matrix} \qquad ( Equation 1.5 )$$

Here, s is a constant which is connected to the expected size of the inclusions. The relationship is predefined or specified by the user.

In the case of the linking of the probabilities, i.e. the integration of a further feature, the a posteriori probability of the preceding feature can in each case serve as prior of the new calculation:

$$p ( s \vert {m}_{2} , {m}_{1} ) = \frac{p ( {m}_{2} \vert s ) \cdot p ( s \vert {m}_{1} )}{p ( {m}_{2} )} = \frac{p ( {m}_{2} \vert s ) \cdot p ( s \vert {m}_{1} )}{{\sum }_{k} p ( {m}_{2} \vert s = k ) \cdot p ( s = k )} \qquad ( Equation 1.6 )$$

In this way, a broader information basis can be used and a more reliable calculation result can be provided. The accuracy of the image analysis is improved.

According to a preferred development of the method, a smoothing of the result obtained through the linking is effected wherein, for determining the maximum probabilities, information is exchanged between an examined pixel and neighbouring pixels.

A smoothing can be effected through a so-called belief propagation (BP). This is also described in detail in the following citation:

Jonataha S. Yedidia, William T. Freeman and Yair Weiss Understanding Belief Propagation and its Generalizations, 2002, TR-2001-22, Pedro F. Felzenzwalb and Daniel P. Huttenlocher, Efficient Belief propagation for Early Vision”, IJCV 2006.

An integration of a probability of the presence of an inclusion in neighbouring pixels into the probability of the presence of an inclusion in the pixel currently being examined can be effected, in particular in that neighbouring pixels exchange information iteratively and the information is updated iteratively. The integration is here effected via the BP.

The information can be present in the form of messages that are exchanged between two pixels and are repeatedly updated, wherein the information in the one pixel can be determined on the basis of information in the pixels of its four-neighbourhood. For this, a method according to so-called belief propagation can be applied. With belief propagation (BP) a class of calculation methods can be described, with which the calculation of so-called marginals or maximum probabilities in Bayesian networks is possible. By “marginals” is preferably meant marginal probabilities. Marginal probabilities are probabilities situated at the edge of a frequency table, which contain relative frequencies of feature combinations.

By “Bayesian network” is preferably meant a directed acyclic (cycle-free) graph, in which node random variables and edges describe conditional dependencies between the variables or features. By “cycle” is preferably meant a pathway from a node to itself, i.e. a route that ends at its output node, and the pathway is cycle-free when it does not lead over two equal nodes; a tree structure can be considered an example of a cycle-free graph. Taking into consideration known conditional independencies, a common probability distribution of all the variables or features involved can be represented by a Bayesian network. Bayesian networks are based on the fundamental idea of a graphic factorization of a probability model.

The application of BP to non-cycle-free graphs, so-called “loopy belief propagation”, is also possible on Markov random fields (MRFs) and is a promising method for using information in image processing or for introducing smoothness conditions. For example, a constant value for different states and zero for the same states could be considered as smoothness conditions. In the present case, the constant value is dependent on the gradient.

Only cycle-free graphs are involved here. Otherwise a Bayesian network would no longer be applicable. The images are therefore considered as Markov random fields.

Images can be modelled as MRFs and each pixel is connected to its four direct neighbours in the Bayesian network. BP is an iterative calculation method in which neighbouring pixels exchange messages. The gist of the messages is: “I (pixel xi) believe that you (pixel xj) belong to the states s with the following probabilities.”

In BP, these messages n can be iteratively updated:

$${n}_{ij}^{new} ( {x}_{j} ) = {\sum }_{{x}_{i}} {f}_{ij} ( {x}_{i} , {x}_{j} ) {g}_{i} ( {x}_{i} ) {Π}_{k ∈ N ( {x}_{i} ) without {x}_{j}} {n}_{ki}^{old} ( {x}_{i} ) , \qquad ( Equation 1.7 )$$

with the influence function fij(xi, xj), of the local measurement gi(xi) and the four-neighbourhood N(xi) around one pixel. Because of the above update formula, the standard BP is also referred to as a sum-product algorithm.

By “Markov random field” (MRF) is meant a statistical model which describes undirected graphs or relationships in a field or image, as opposed to a directed acyclic graph (Bayesian network), and which can be used for segmenting images, wherein a feature of a specific pixel is placed in relation to the corresponding feature in neighbouring pixels. By “undirected” is preferably meant a graph which contains no direction information at the edges between two nodes; the relationship between two nodes is therefore symmetrical.

Should the state of a pixel with the maximum probability now be calculated with BP, then in relation to the above equation 1.7, the maximum can be used instead of the sum. In order to save computing time, in the BP the negative logarithm of the probabilities can be used instead of the probabilities. From a max-product algorithm, i.e. a calculation method based on the products of messages (probabilities), a min-sum algorithm is thereby created, i.e. a calculation method based on the sum of negative logarithms of probabilities.

The negative logarithms of the probabilities calculated in the preceding step can be entered or considered in the BP. The influence function is inversely proportional to the absolute amount of the gradient, capped at a maximum amount.

Gaussian image pyramids can be used to accelerate the calculation. By “image pyramids” is here preferably meant hierarchical divisions of the image information, wherein individual pyramid steps contain different image infomation in relation to local resolution and contrast. Neighbouring pixels can be considered and high-contrast structures become more easily recognizable, but less well locatable. A small resolution step is assumed, in order to only still have to analyse the relevant image regions on higher resolution steps.

Furthermore, a checkerboard update pattern can be used for updating the messages in the BP. By “checkerboard update pattern” is meant the following: the pixels in the image are divided into two groups, alternating like the squares on a checkerboard. A “black” group and a “white” group. Wherein “black” and “white” here do not refer to the greyscale value or the colour of the pixels, but depend solely on the position of the pixel. In the 1st iteration of the update process, only the messages of the “black” pixels are updated, in the 2nd iteration, only the “white”, in the 3rd the “black” again and so on.

According to a preferred development of the method, the method is set via at least one of the following parameters:

a mask size U of the median filter;

a sensitivity value for the first feature and optionally a sensitivity value for at least one further feature;

a threshold value for the probability that an inclusion is present (confidence);

wherein the confidence desired by a user in the detection result can be set above the confidence threshold value. The higher the confidence threshold value is selected, the greater must be the final probability of a pixel before it is declared to be a void. The confidence threshold value controls the decision with reference to the calculated probability: from what probability is a void to be indicated to the user? The basic calculation does not change due to the confidence value.

By “mask size” (so-called locality) is preferably meant the size of a local surroundings U of a respective pixel, in which a filter is applied (so-called neighbourhood).

The sensitivity value multiplied by x84-value of the difference image results in the threshold value tin the likelihood function p(m|s) for the probability of a greyscale value in the event that the pixel depicts an air inclusion. The gradient a in the likelihood function is calculated depending on the threshold value t and is thus likewise indirectly influenced by the sensitivity. In summary, the algorithm reacts more sensitively to voids, the higher the sensitivity. By “confidence value” is meant that here a user can predefine what uncertainty he accepts in the calculation.

According to a preferred development of the method, the method is additionally set via at least one of the following parameters:

a smoothness value for a second feature;

a smoothness penalty value for the smoothing method;

wherein the desired smoothness conditions can be set via the smoothness value and the smoothness penalty value.

The smoothness value relates to the gradient feature (page 15, line 21) and defines how rapidly the probability falls when it has not been possible to find a compatible partner for the edge (formerly variable s—now variable z in the exponential function). The setting is effected manually. The smoothness penalty value relates to the belief propagation. An influence function multiplier is to be seen as smoothness penalty value. The influence function results for each pixel from the absolute amount of the gradient, wherein the influence is zero when the gradient is maximum, and the influence is 1 when the gradient is zero. It is thus set, how high the influence of the four-neighbourhood is. When in the case of a very high smoothness penalty value, all the pixels in the image obtain the same result (void or background). In the case of a very small smoothness penalty value, only the measurement of the individual pixel counts. The setting is effected manually.

The threshold value t for the absolute amount of a gradient likewise results indirectly from the x84 criterion multiplied by the sensitivity. The threshold value for the probability (confidence) should be set significantly greater than 0.5 in order to obtain a corresponding certainty.

According to a preferred development of the method, the method is carried out iteratively for all the relevant pixels, whether all the pixels of an image or all the pixels of a region selected manually by a user (specific examination region, e.g. in order to save computing time) in an image.

According to a preferred development of the method, the method is carried out on the basis of an X-ray image as original image.

At least one of the above-named objects is also achieved by a computer program according to claim 11 and a storage medium according to claim 13. The computer program can be provided for the automated application of a method according to one of the preceding claims, wherein by “automated” can preferably be meant a process in which, after recording of an original image and formation of a difference image, the result image can be calculated and evaluated and output without further user inputs, optionally already in connection with a statement on the quality or useability of the examined material.

### BRIEF DESCRIPTION OF THE DRAWINGS

The invention is explained in even more detail with the aid of the following figures. Unless explicitly stated otherwise, individual features of the embodiment examples shown in detail can in principle also be combined with each other.

There are shown in:

FIG. 1 an X-ray image of an adhesive surface with air inclusions;

FIG. 2 a difference image between an original image as shown in FIG. 1 and a low-pass filtered image, wherein the difference image serves as basis for a calculation of a result image;

FIG. 3 a result image, as can be established under favourable conditions with a standard calculation based on the difference image shown in FIG. 2, wherein both inclusions and parts of the background are represented as inclusions; and

FIG. 4 an example of a result image, as can be calculated with a method according to the invention based on the difference image shown in FIG. 2.

### DETAILED DESCRIPTION OF THE INVENTION

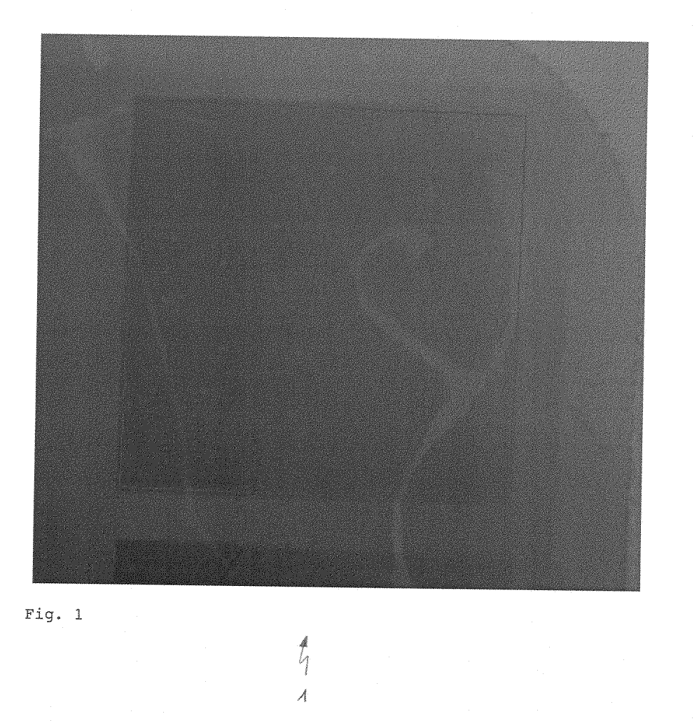

FIG. 1 shows an original image 1, specifically an X-ray image of an adhesive surface with air inclusions, wherein the air inclusions are represented brighter than the background. Approximately two-thirds of the image surface are delimited by a largely centrally arranged frame which defines a specifically selected examination region for an image analysis. In the image 1 shown, a greyscale value progression is present, which can be recognized in that the image background in the top right-hand corner is brighter than in the bottom left-hand corner. Such a greyscale value progression makes it difficult to determine air inclusions via a simple threshold value formation.

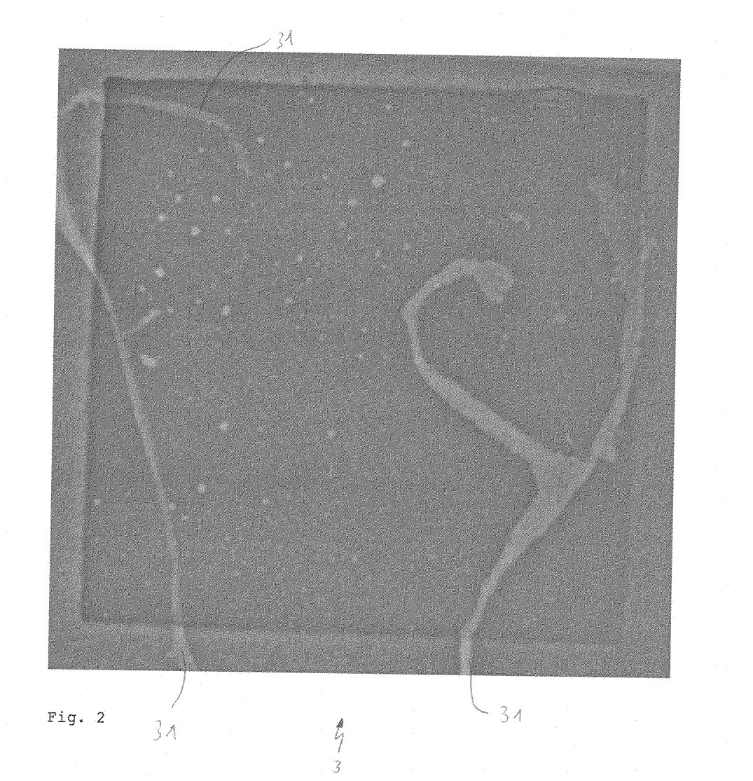

FIG. 2 shows a difference image 3 which has been calculated from the original image of FIG. 1 and a low-pass filtered image (not represented). Air inclusions 31 can be recognized.

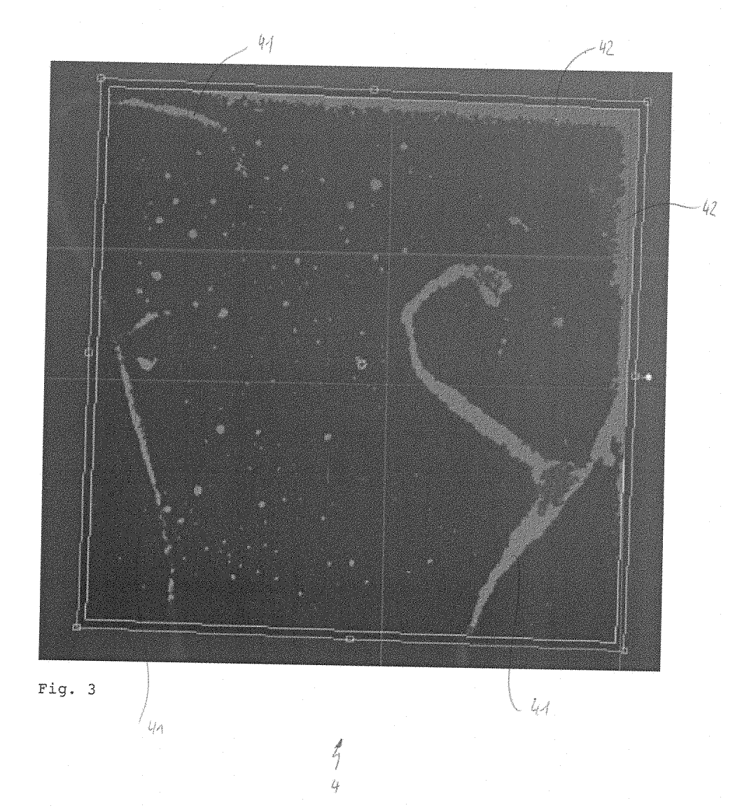

FIG. 3 shows a result image 4, as can be established under favourable conditions with a standard calculation based on the difference image shown in FIG. 2. Both inclusions 41 and parts of the image background 42 have been calculated as inclusions, wherein the background 42 first clearly emerges in the result image 4. Here it is known that these are background 42 and not air inclusions only because the calculation result could be checked with the method according to the invention. The result of the calculation is therefore not sufficiently accurate.

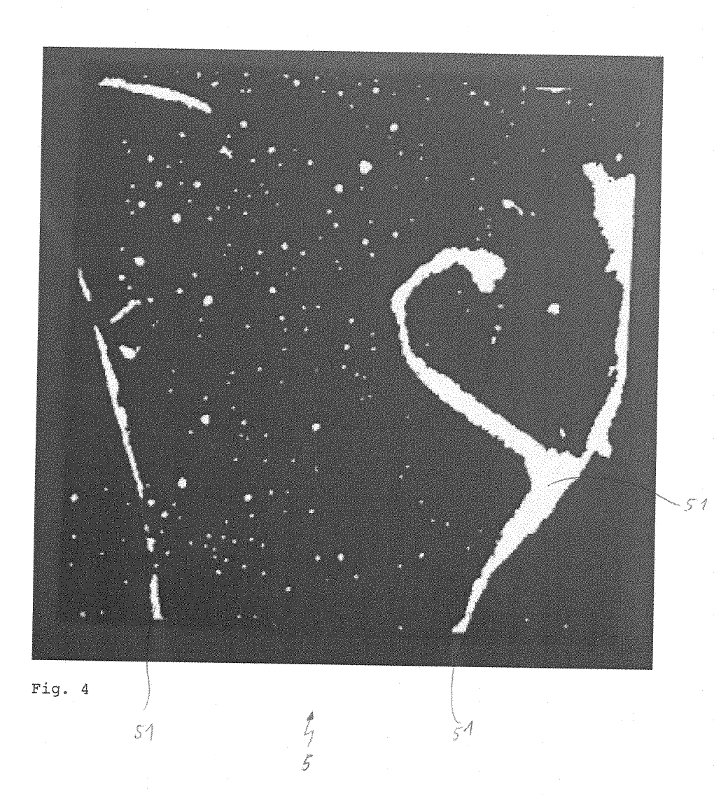

FIG. 4 shows a result image 5, as can be calculated with a method according to the invention based on the difference image shown in FIG. 2, wherein it is apparent that, in the result image 5, inclusions 51 have been clearly separated from background. The background 41 incorrectly calculated in the result image 4 shown in FIG. 3 is no longer visible in the present result image 5. The calculation result is more accurate. At the same time, the outlines and thus the surfaces or volumes of the inclusions 51 can be determined more accurately, which results from the higher-contrast demarkation of the edges of the inclusions. It is also apparent that, in the case of the large elbow-shaped inclusion 51 situated on the right in the result image 5, the entire inclusion 51 is hollow inside, i.e. has a larger volume than the inclusion 41 calculated on the basis of the result image 4 shown in FIG. 3. This is because, in the case of the inaccurately calculated inclusion 41, regions are present which are apparently supposed not to be hollow spaces, wherein the improved accuracy is likewise apparent in the calculation with the method according to the invention.

While the foregoing is directed to several embodiments of the present invention, other and further embodiments and advantages of the invention will be apparent to those of ordinary skill in the art based on this description without departing from the scope of the invention, which is to be determined by the claims that follow.

### LIST OF REFERENCE NUMBERS

1 original image
2 filtered image
3 difference image
31 inclusions in the difference image
4 result of standard VC (calculated image)
41 inclusions in the calculated result image
42 background in the calculated result image
5 result of VC according to the invention (calculated image)
51 inclusions in the calculated result image
xc threshold value for likelihood (confidence)
xs smoothness value, in particular for the gradient feature
Pxs smoothness penalty value (smoothness penalty)
SM sensitivity value
Sm1 sensitivity value for feature 1
Sm2 sensitivity value for feature 2
a gradient which results from an image noise
BP belief propagation
c constant for likelihood function in connection with the conditional probability, in particular small constant<0.5
fij(xi, xj) influence function
g(x1), g(x2) gradient pair
gi(xi) local measurement
Δl greyscale value intensity of the difference image
m feature generally, e.g. m1 or m2 ora further feature
m1 first feature, in particular greyscale value or greyscale value intensity
m2 second feature, in particular gradient feature
med median
MRF Markov Random Fields
n message
nij (xj) message which has been established on the basis of information in and around a pixel i
N(xi) four-neighbourhood
p(m|s) conditional probability according to Bayes' theorem for the feature m, when the state s is present (so-called likelihood function)
p(s) prior
p(s|m) sought probability according to Bayes' theorem, that an inclusion is present in a pixel (so-called a posteriori probability)
s complementary (fixed) state: inclusion is present or not
z constant, which is associated with the expected size of an inclusion (specified on the right-hand result side of the likelihood function)
σX84(x) median of the absolute deviation from the median (med)
t threshold value for the absolute value of a gradient
U local surroundings of a pixel at the position x; is referred to in connection with the application of a filter and in the case of accurate definition as mask size (locality)
VC void calculation
xi first pixel
xj second pixel

1. A method for determining inclusions (51) in a closed volume on the basis of an image (1) of the volume in which, for a respective pixel depending on a threshold value for a first feature of the pixel, a yes/no statement is made as to whether an air inclusion is present in the pixel, wherein the first feature relates to a difference image (3) from an original (1) of the image and a filtered image of the image,
characterized in that the filtered image is formed through a median filter.

2. The method according to claim 1, characterized in that the threshold value is automatically determined based on a noise in the difference image (3).

3. The method according to claim 1, characterized in that the yes/no statement is only made right at the end after consideration of all the features based on a probability of the presence of an inclusion (51) established for a respective pixel.

4. The method according to claim 3, characterized in that a second feature of the pixel is defined and a probability is calculated for the first and second feature, respectively.

5. The method according to claim 4, characterized in that the first and second features are combined with each other stochastically and the probabilities of the first and second features are linked to each other.

6. The method according to claim 5, characterized in that a smoothing of the result obtained through the linking is effected wherein, for determining the maximum probabilities, information is exchanged between an examined pixel and neighbouring pixels.

7. The method according to one of the preceding claims 4, characterized in that the method is set via at least one of the following parameters:
a mask size (U) of the median filter;
a sensitivity value (Sm1) for the first feature and optionally a sensitivity value (Sm2) for at least one further feature;
a threshold value (xc) for the probability that an inclusion is present.

8. The method according to claim 6, characterized in that the method is set via at least one of the following parameters:
a mask size (U) of the median filter;
a sensitivity value (Sm1) for the first feature and optionally a sensitivity value (Sm2) for at least one further feature;
a smoothness value (xs) for a second feature;
a smoothness penalty value (Pxs) for the smoothing method;
a threshold value (xc) for the probability that an inclusion is present.

9. The method according to claim 1, characterized in that it is carried out iteratively for a plurality of neighbouring pixels.

10. The method according to claim 1, characterized in that the method is based on a difference image (3) formed from an X-ray image and a median-filtered image.

11. A computer program for carrying out the method according to claim 1 when the computer program is loaded into a computer.

12. A computer program according to claim 11, which is formed for carrying out the method in an automated manner, in relation to an image or a selected image region.

13. A storage medium with a computer program according to claim 11 stored in the storage medium.

14. (canceled)
